(19) United States
(12) Patent Application Publication
(10) Pub. No.: US 2021/0142403 A1
(43) Pub. Date: May 13, 2021

(54) System For Efficient Solution Provision Using Automated Processing

(71) Applicant: CommunityLend Holdings Inc., Toronto (CA)

(72) Inventors: Michael GARRITY, Toronto (CA); Paul SEHR, Toronto (CA)

(73) Assignee: CommunityLend Holdings Inc., Toronto, ON (CA)

(21) Appl. No.: 17/046,596

(22) PCT Filed: Apr. 10, 2019
(86) PCT No.: PCT/CA2019/000045

§ 371 Date: Oct. 9, 2020

Related U.S. Application Data
(60) Provisional application No. 62/656,139, filed on Apr. 11, 2018.

(51) Int. Cl. G06Q 40/02; G06Q 10/10; G06Q 30/00; G06Q 50/26; G06K 7/14; G06K 7/08

(52) U.S. Cl. CPC G06Q 40/025; G06Q 10/10; G06Q 30/0185; G06Q 20/202; G06K 7/1413; G06K 7/087; G06Q 50/265

(57) ABSTRACT

A method system for providing an efficient solution to lead management and automated loan processing is described. The method includes receiving user information at a lead management system for requesting a service. If a loan is requested, the user information previously entered is utilized to populate a loan application form, which expedites loan processing. A system including a mobile application for lead management and automated loan processing, in communication with a loan application processing server provide an efficient method of processing loan applications. The system may be utilized in approving loans when requesting services such as home improvement services requiring a large cash investment.

### RELATED APPLICATIONS

This application claims priority from U.S. provisional application 62/656,139 filed on Apr. 11, 2018, entitled “System for Efficient Solution Provision using Automated Processing”, and the contents of which are herein incorporated by reference in their entirety.

### FIELD OF THE INVENTION

The invention relates generally to the field of mobile applications, and in particular, to a system for efficient solution provision using automated loan processing.

### BACKGROUND OF THE INVENTION

Consumer loan applications offered through merchants have traditionally been processed by collecting all the data needed to assess the applicant upfront, either through a computer application, a website or on paper. After the application process, loan documents would then need to be filled out (either electronically or manually) and submitted manually via fax or as email attachments. Additional documentation such as identification, void cheques, and invoices also need to be collected and forwarded to the lender before the loan can be approved.

Home improvement services and installations are common. However, due to the high cost, most consumers prefer to finance their purchase and installation costs. The financing application process described above would often take several minutes or longer for the merchant to complete. The subsequent final approval process including the assembly of the additional documents could take hours or even days.

### SUMMARY OF THE INVENTION

In one aspect of the present invention, there is provided a method performed by a mobile lead management application. The method comprises receiving user information for a requested service by a user, verifying the user information, and creating a loan application form in response to activating a user interface element. Upon receiving loan information into a form, the loan application form is sent over the network to a loan application processing server. Upon receiving an approval indication from the loan application processing server, at least one document for the user to endorse is generated by the mobile lead management application.

In one embodiment, the method further comprises receiving an endorsement of the at least one generated document by means of a signature entered by a stylus or a finger.

In one embodiment, the method further comprises capturing a photograph of a void cheque belonging to the user, and uploading the photograph to the loan application server.

In one embodiment, the approval indication contains banking information for the user.

In one embodiment, the method further comprises: retrieving the user information received for lead initiation by scanning a barcode on an identification card of the user, and sending the user information over a network to the loan application processing server.

In one embodiment, verifying the user information comprises scanning and decoding a barcode on an identification card of the user.

In one embodiment, the method further comprises populating the loan application form with user information verified by the scanning and the decoding of the barcode.

In one embodiment, verifying the user information comprises receiving, via a peripheral magnetic strip reader, user information from a magnetic strip on an identification card of the user.

In one embodiment, the method further comprises: capturing a first photograph of the user using the camera in the mobile device, capturing a second photograph of an identification card of the user, using the camera in the mobile device; and sending the first and second photographs along with the loan application form over the network to the loan application processing server for verification.

In another aspect of the present invention there is provided a method performed by a loan application processing server. The method comprises receiving over a network, user information and a loan application form, for a user. A credit check to determine a credit rating for the user is performed. An approval or a reception of the loan is made based at least in part on the loan application form and the credit rating. A lead management system is updated to confirm that the loan application has been approved.

In one embodiment, the method further comprises receiving a photograph of a void cheque belonging to the user.

In one embodiment, receiving the user information comprises receiving the user information from the lead management system.

In one embodiment, the method further comprises accessing a service which interprets the user information and performs checks including an identification check and a criminal background check.

In one embodiment, the approving or rejecting is further based on one of the identification check and the criminal background check.

In one embodiment, the method further comprises receiving a first photograph of the user, receiving a second photograph of an identification card of the user, and verifying the identity of the user by comparing the first photograph and the second photograph.

In yet another aspect of the present invention there is provided a system of lead management and automated loan processing. The system comprises a mobile device running a mobile lead management application, a lead management system, and a loan processing server. The mobile lead management application running on the mobile device is configured for receiving user information and populating a loan application form. The mobile lead management application is further configured for sending the user information and loan application form to the loan processing server. The mobile lead management application is also configured for generating documentation for the user to sign in response to receiving an indication from the loan application processing server that the loan application has been approved. The lead management system is accessible by the mobile lead management application and receives information entered via the mobile lead management application. The loan application server is configured for receiving the user information and loan application form. The loan application server is also configured for determining whether to approve or reject the loan application form, as well as for selecting a lender, and for sending an updated to the lead management mobile application.

In one embodiment, the loan application server is accessible via an administrator interface.

In one embodiment, the system further comprises a point-of-sale system deploying a lead management user interface. The point-of-sale system may be in communication with a plurality of lender partners.

### BRIEF DESCRIPTION OF THE DRAWINGS

FIG. 1 depicts examples of home installation services;

FIG. 2 depicts a proposed workflow of a lead management system which shows entities and steps involved in the process of ordering a home installation service;

FIG. 3 depicts a more detailed workflow process of a lead management system showing the steps involved in ordering a home installation service;

FIG. 4 depicts sample screen shots from the lead management mobile application;

FIG. 5A is a sample initial user interface of the lead management system;

FIG. 5B is a sample home improvement loan application screen;

FIG. 5C is a home improvement loan status and confirmation screen;

FIG. 6A is a sample lead management dashboard screen;

FIGS. 6B and 6C show additional content of the lead management dashboard screen;

FIG. 7 is a sample lead screen overview of the lead management system;

FIG. 8 is a schematic diagram of a system combining lead management and automatic loan processing;

FIG. 9 is a block diagram showing some components of the lead management and loan processing mobile application; and

FIG. 10 is a flow diagram showing the steps used to populate the loan application form based on a lead provided by the lead management system.

### DETAILED DESCRIPTION OF THE EMBODIMENT

FIG. 1 depicts examples of home installation services 100, which may be ordered by an end consumer. Each service has an average cost, and it is desired for a merchant to grow future trust in its brand, generate leads for other services, and seek to be the preferred provider for those services. For example, service 110 is a duct cleaning and/or duct sealing service. The average cost of such a service is typically between $250 and $2000. It is desirable for a merchant providing such a service to grow future trust in the merchant's brand. Additionally, providing this service may lead to other orders, by the same consumer, of related services such as heating and/or cooling. Advantageously, the merchant may become the preferred provider for those services. As another example, when a consumer orders the carpet cleaning service 120, which has an average cost of $150-$250, this may provide a lead to the consumer for the purpose of encouraging them to order a floor replacement service. For example, the carpet floor may need to be replaced with newer carpet, or with another type of flooring such as hardwood, laminate, ceramic tiles, or porcelain. As another example, a painting service 130, which typically costs $2500-$3000, may provide a lead to a complex service in the future, such as installing wallpaper.

FIG. 2 depicts a proposed workflow 200 of a lead management system. The workflow shows entities and steps involved in the process of ordering a home installation service through a lead management system. The workflow starts at step 202. At 202 a consumer, looking for a home installation service contacts a retailer or original equipment manufacturer (OEM) to place an order for a home installation. As shown at 204, the order may be placed on the world wide web, for example on the website of any of the major home improvement merchants or suppliers. Alternatively, the retailer may have a call center, which accepts such orders. The order may also be placed at a retail store or in-home with an installer. All of the options in 204 represent alternative entry points into the lead management system. As the order is placed, the retailer has a home install lead 206. Given the cost of most home installation services, a significant number of consumers obtain financing 208 to pay for the service. If the home install consumer is approved for financing at step 210, then installation occurs at 220. At 230, the retailer/OEM as well as the installer both are paid in full by the lender that provides the financing to the home install lead (consumer). In order to provide a fulfilling customer service experience, it is desirable to speed up the financing option 208 so the consumer does not have to wait for days before the installation may begin.

FIG. 3 depicts a more detailed workflow process 300 showing the steps involved in ordering a home installation service via a lead management system. At the first step 302, a new lead for a consumer is entered into the workflow process of the lead management system, using one of the options 204 as described with reference to FIG. 2. At 304, the consumer applies for financing and gets an immediate pre-approval. The details of how the consumer gets an immediate approval for financing is explained in more detail with reference to FIGS. 8-10. Once an approval for financing is obtained, the credit amount may be applied to any one or more of many services that are offered by the retailer servicing the request. At step 306, the lead is acknowledged and a meeting is scheduled, by the retailer, with the consumer to discuss the consumer's needs. If necessary, or appropriate, at 308 an in-home consultation may be conducted to recommend products and services that serve the consumer's needs, and to provide a quote for the project. Assuming the consumer has been approved for enough financing to cover the project cost then at step 310 the sale is made and the payment for the requested products and services is processed. At step 312, installation is completed and the consumer provides a signature indicating their satisfaction that the work has been completed. The sale completion is then processed.

FIG. 4 depicts a sample user interface for a mobile application 400 that is part of the lead management system. The mobile application 400 is designed for service providers (i.e. retailers), lead generators, and installers to manage their business with the platform. Service providers are able to optimize their time by eliminating the need to do manual paperwork and having to go back and forth to the office to upload documents. The mobile application 400 allows service providers to work from anywhere, with access to their orders, sales. The mobile application 400 also facilitates business reporting. Lead generators can easily add leads, provide quotes and sell home installation jobs on the go. The lead management system accepts pictures taken by the mobile application app 400 from the job site. The pictures are uploaded into the lead management system to be part of the record for the respective job. Financing could be requested via the mobile application 400 either directly or as part of the lead management system workflow as indicated above. As an alternative to the mobile application 400, a similar interface could be provided at a point of sale (POS) terminal.

FIG. 5A is a sample user interface 500 for the lead management system. The interface 500 contains a form that may be filled out at the outset of the process of requesting a home service installation. A customer service representative at a retailer may enter the customer information using the form shown. Among the user interface elements on the form is an element 510 that allows the customer to indicate if they are interested in applying for financing, such as a home improvement loan. FIG. 5B is a customer branded portal 540 for home improvement loan applications. Portal 540 contains various components, some of which provide information such as 544, which explains how the financing works. Element 542 initiates a loan application. Element 546 is a loan calculator which provides estimates for a monthly amount that the consumer pays based on the amount of money being financed. The lead management system keeps track of consumers, and detects if the consumer has already been approved for a home improvement loan, as shown in the status screen 580 of FIG. 5C. Advantageously, the lead management system minimizes the amount of data that would normally have to be reentered to apply for a loan since the consumer information is entered at the outset.

FIGS. 6A-6C show contents of a dashboard screen 600 for the leads management system component relating to a particular retailer. The dashboard screen 600 contains a list of the leads grouped by the action that needs to be performed. For example, the list of leads 602 contains new lead opportunities that need to be reviewed. The list of leads 604, on the other hand, is a list of leads for which an appointment with the member needs to be scheduled. For each lead in either lists, the information maintained includes a lead ID that uniquely identifies the lead, the type of service requested, the warehouse that will service that lead, the member name and phone number, and a book date.

A lead list 606 is also included in the dashboard for listing members for which a quote needs to be provided after their appointment has been scheduled. Subsequent to providing the quote, if the member decides not to move forward the lead is cancelled. List 608 contains leads for which the member has approved the quote provided, and is moving forward with a purchase. Lead list 610 is for confirming work completion once the job is completed and all paperwork has been submitted.

FIG. 7 is a detailed lead screen 700 of the lead management system. A progress tracker 710 displays the status of a particular lead within the workflow of the lead management system. Member information 720 is an editable form showing basic contact information for the member. At 730, any document attachments saved for a dealer's own use are listed. At 740, notes added by all the users that have interacted with the lead are accessible. This includes dealers, vendors, and call center representatives. Member escalations are shown at 750. These include any escalations (i.e. complaints) associated with this lead initiated by the member. Additional lead information is included at 760. At 770 answers to lead qualification questions when the lead was originally submitted are accessible. Finally, at 780, documents for the retailer's use may be accessed.

Turning now to FIG. 8, an integrated system for lead management and automatically processing loan applications for home improvement in real time is generally indicated by the reference numeral 800. The lead management system, described above, is represented by 850. Loan application processing software is run on a loan application-processing server 812 accessible to an administrator user interface 814, and accessible from lead management system 850. The administrator user interface 814 can access the loan application processing software through an internet connection. Alternatively, mobile application 818 may access the lead management system 850, and as part of the process described, the lead management system may forward the request for a home improvement to the loan application-processing server 812. The loan application-processing server 812 is also in communication with a plurality of lender partners 816.

Merchants can access the loan application-processing server 812 via a lead management user interface running on mobile application 818. Alternatively, the lead management user interface can be deployed via a web interface, or an application programming interface (API) integrated directly into the point-of-sale system in communication with a plurality of lender partners 816. In another embodiment, the merchants may access the loan application-processing server 812 via an administrator interface 814.

FIG. 9 is a schematic drawing and shows the components of the merchant user interface 818 deployed via a mobile app. As illustrated, the interface displays information from software modules that enable entering a financing request via the lead management system component of the application 901. Much of the information needed for loan processing would have already been entered by the lead management system component of the mobile application. However, a bar code scan 903 of a customer's ID may be made as a verification step. The loan is submitted by component 905, and information on the loan are displayed and/or updated by 907. Any data necessary from the document engine 909 is obtained. Some or all of these modules are in communication, and may exchange data with the loan application-processing server 812.

FIG. 10 is a flow diagram showing the steps 1000 the system performs for processing loan applications in real time. The steps assume that a lead has been entered into the lead management system 850 via application 818. If the consumer wishes to apply for a home improvement loan, by activating element 510 in FIG. 5A for example, then a new loan form is created at 1002. In step 1004, the merchant inputs loan data into a form presented by the user interface on mobile application 818. Much of the information required for a loan application may already have been entered as part of the lead initiation. In this case, step 1004 may just comprise entering additional information specific to the loan being applied for, as opposed to having to enter the entire consumer's information such as name, address, and so on. This saves time and eliminates duplication of effort. The additional loan data can include the loan amount and type of item being purchased by a customer or loan borrower. In step 1006, the borrower's personal information may be gathered via the borrower's identification, for verification purposes since the personal information has already been provided through the lead management system. The merchant can select to take a photograph of a 2-D bar code on the borrower's identification using the camera in the mobile device. When selected, the merchant user interface on mobile application 818 will deploy the camera and the merchant can take the photograph. Once the photograph is captured, the barcode is scanned and decoded for the borrower's personal information. The information obtained is compared and verified against the personal information provided by the lead management system and any discrepancies are flagged. This process occurs through the device camera within the mobile application 818. Alternatively, a magnetic strip on the borrower's identification can be “swiped” using a peripheral magnetic strip reader. If none of these methods is available to the merchant, the numbers on the borrower's identification can be entered into the form manually.

In step 1008, the information provided by the lead management system, and verified against the scanned information from step 1006 is used to populate the form. The borrower information is matched to the appropriate fields and automatically inserted.

The completed form is then submitted to the loan application-processing server 812 in step 1010. In step 1012, the loan application-processing server accesses a service that interprets the data and then performs an identification check, a criminal background check, a credit bureau check, and then checks the borrower's credit rating. If the identification, criminal, and credit check are not verified, then the borrower is rejected in step 1014. If the identification, criminal, and credit check are verified, then the borrower is accepted in step 1016 and an appropriate lender and rate are chosen based on what is available to the borrower for that particular merchant and the borrower's credit rating and history.

In step 1018, the merchant optionally can adjust parameters of the loan to customize the loan for the borrower. An example of the parameters the merchant can adjust is loan amortization period.

In step 1020, additional borrower information is collected. This information can be used for further identification of the borrower, to demonstrate the merchant's due diligence in verifying the borrower's identification, or for auditing purposes. In one example, the user interface on application 818 prompts the merchant to take a photo of the identification being used by the borrower and a photo of the borrower to secure the loan. The photographs can be taken by the camera within the mobile device, which is concurrently running the application 818. In this example, the mobile application 818 will deploy the camera and the merchant can take the photographs. Once the photographs are captured, they are sent to the loan application server 812.

In step 1022, the mobile application 818 generates appropriate documents for the borrower to sign. The documents can be rendered on the mobile device running the mobile application 818. In step 1024, the borrower endorses the documents by signing in the appropriate spot with a finger or stylus in the appropriate field.

In step 1026, the mobile application 818 prompts the merchant for the borrower's banking information. The application 818 can prompt the merchant to take a photo of a void cheque belonging to the borrower. If the merchant elects to take the photograph at that time, the merchant user interface deploys the camera in the mobile device that sends the captured images from the device to the loan application server. If the merchant chooses to take the photographs at a later time. Alternatively, the void cheque can be scanned by a peripheral scanner or through the mobile device application, and uploaded to the loan application-processing server 812 at a later time.

At step 1028, the loan and banking information are sent to the lead management system 850, to confirm that the work may begin on the home improvement project as the loan has been approved.

Advantageously, information previously entered for the user at the time the lead is entered in the lead management system, is used to approve and speed up the process of obtaining a loan for paying for a particular service.

While specific embodiments have been described and illustrated, such embodiments should be considered illustrative only, and should not serve to limit the accompanying claims.

1. A method performed by a mobile lead management application, the method comprising:
a) receiving user information for a requested service by a user;
b) verifying the user information;
c) creating a loan application form in response to activating a user interface element;
d) upon receiving loan information into a form, sending the loan application form, over the network, to a loan application processing server; and
e) upon receiving an approval indication from the loan application processing server, automatically generating at least one document for the user to endorse.

2. The method of claim 1, further comprising receiving an endorsement of the at least one generated document by means of a signature entered by a stylus or a finger.

3. The method of claim 1, further comprising capturing a photograph of a void cheque belonging to the user, and uploading the photograph of the void cheque to the loan application processing server.

4. The method of claim 1, wherein the approval indication contains banking information for the user.

5. The method of claim 1, further comprising:
a) retrieving the user information received for lead initiation by scanning a barcode on an identification card of the user; and
b) sending the user information, over a network, to the loan application processing server.

6. The method of claim 1, wherein verifying the user information comprises scanning and decoding a barcode on an identification card of the user.

7. The method of claim 6, further comprising populating the loan application form with user information verified by the scanning and the decoding of the barcode.

8. The method of claim 1, wherein verifying the user information comprises receiving, via a peripheral magnetic strip reader, user information from a magnetic strip on an identification card of the user.

9. The method of claim 1, further comprising:
a) capturing a first photograph of the user using the camera in the mobile device;
b) capturing a second photograph of an identification card of the user, using the camera in the mobile device;
c) sending the first and second photographs along with the loan application form over the network to the loan application processing server for verification.

10. A method performed by a loan application processing server, the method comprising:
a) receiving, over a network, user information for a user;
b) receiving, over the network, a loan application form for the user;
c) performing at least a credit check to determine a credit rating for the user;
d) approving or rejecting the loan application based at least in part on the credit rating;
e) if approving the loan application, then selecting a lender to disburse a loan based at least in part on the loan application form and the credit rating; and
f) updating a lead management system to confirm that the loan application has been approved.

11. The method of claim 10, further comprising receiving a photograph of a void cheque belonging to the user.

12. The method of claim 10, wherein receiving the user information comprises receiving the user information from the lead management system.

13. The method of claim 10, further comprising accessing a service which interprets the user information and performs checks including an identification check and a criminal background check.

14. The method of claim 13, wherein the approving or rejecting is further based on one of the identification check and the criminal background check.

15. The method of claim 10, further comprising:
a) receiving a first photograph of the user;
b) receiving a second photograph of an identification card of the user; and
c) verifying the identity of the user by comparing the first photograph and the second photograph.

16. A system of lead management and automated loan processing, the system comprising:
a) a mobile device running a mobile lead management application;
b) a lead management system; and
c) a loan processing server;
wherein:
i) the mobile lead management application running on the mobile device is configured for: receiving user information and populating a loan application form, sending the user information and loan application form to the loan processing server, and generating documentation for the user to sign in response to receiving an indication from the loan application processing server that the loan application has been approved;
ii) the lead management system is accessible by the mobile lead management application and receives information entered via the mobile lead management application; and
iii) the loan application server is configured for: receiving the user information and loan application form, determining whether to approve or reject the loan application form, selecting a lender, and sending an update to the lead management mobile application.

17. The system of claim 16, wherein the loan application server is accessible via an administrator interface.

18. The system of claim 16, further comprising a point-of-sale system deploying a lead management user interface, the point-of-sale system in communication with a plurality of lender partners.
